(19) United States
(12) Patent Application Publication
(10) Pub. No.: US 2009/0030624 A1
(43) Pub. Date: Jan. 29, 2009

(54) SYSTEMS AND METHODS FOR VALIDATING POWER INTEGRITY OF INTEGRATED CIRCUITS

(76) Inventor: Jane He, Ottawa (CA)

Correspondence Address: KNOBBE MARTENS OLSON & BEAR LLP, 2040 MAIN STREET, FOURTEENTH FLOOR, IRVINE, CA, 92614, US

(21) Appl. No.: 12/122,544

(22) Filed: May 16, 2008

Related U.S. Application Data
(60) Provisional application No. 60/938,407, filed on May 16, 2007.

(51) Int. Cl. G06F 19/00

(52) U.S. Cl. 702/60; 702/122

(57) ABSTRACT

A power integrity system executes one or more test algorithms, such as a suite of test software that may be written in low level language that is coupled with a test environment housing an integrated circuit and/or printed circuit board, in order to identify possible power integrity issues with the integrated circuit and/or printed circuit board.

### CROSS-REFERENCE TO RELATED APPLICATIONS

This application claims priority from U.S. Provisional Application No. 60/938,407, filed May 16, 2007, which is hereby incorporated by reference in its entirety.

### BACKGROUND OF THE INVENTION

1. Field of the Invention

This invention relates to testing of integrated circuits and/or Printed Circuit Boards (PCBs) in order to validate power integrity of the devices.

2. Description of the Related Technology

One consideration of designing an integrated circuit (“IC”) and/or a PCB is the method and circuitry for providing and distributing power reliably from the source (power supply) to destinations (each layer of the PCB as well as each pin of chips in various environmental parameters). One worst case is when multiple groups of pins of chips are concurrently active, the power supplied to those pins may not be sufficient to power the pins and, thus, address and/or data corruption may occur.

### SUMMARY

In one embodiment, a chip and/or its PCB assembly are stressed by executing a set of test software algorithms. Power integrity measurements are taken as the chip is being stressed in order to validate the power integrity of the PCB and its associated chips without human intervention. In one embodiment, the systems and methods described herein provide the hardware designers with insights before designs are produced. For example, in one embodiment a software test method automates the power integrity characterization processes without human intervention during prototype verification stage. The systems and methods described herein may also be used to qualify new sources of PCB or chip suppliers. They may also be used for field troubleshooting power integrity related issues.

Power design analysis is one of the most challenging and complicated jobs among signal integrity designers. First of all, it is difficult and very time consuming to have experienced signal integrity specialists model everything correctly; second, it is nearly impractical to characterize the power integrity in the lab with all product temperature ranges. For example, many power integrity problems are not seen until products are released to customers. Thus, power integrity issues usually are not straightforward as symptoms may be (1) intermittent, (2) data pattern related (e.g., different customers can experience different failures as applications vary from site to site), and/or (3) hard to detect in the lab since labs may not run high volume traffic as a customer site.

One method for reducing power integrity issues is the addition of decoupling capacitors to certain pins of a chip or PCB, where the capacitors function as small charge pumps. However, the addition of capacitors to a PCB often results in a barnacle-like structure and/or appropriate capacitors may not be added to a chip due to layout constraints.

In one embodiment, a computerized method for analyzing power integrity of an integrated circuit having a plurality of pins configured for coupling with an electronic device, wherein a first subset of the plurality of pins comprise power pins that are configured for coupling with a voltage source via the electronic device, a second subset of the plurality of pins comprise ground pins configured for coupling with a reference voltage via the electronic device, and a third subset of the plurality of the pins comprise data pins configured for coupling with one or more data buses that communicate data bits via the electronic device, comprises:

(a) identifying a set of N data pins that are each associated with one of the data buses;

(b) determining a plurality M of N-bit reset patterns and a corresponding plurality of N-bit test patterns;

(c) selecting a first memory address of the integrated circuited for storage of data bits received by the N data pins;

(d) selecting one of the N-bit reset patterns;

(e) transmitting the selected N-bit reset pattern to the N data pins;

(f) selecting one of the plurality of N-bit test patterns that correspond to the selected N-bit reset pattern;

(g) transmitting the selected N-bit test pattern to the N data pins;

(h) reading a value of the first memory address;

(i) comparing the selected N-bit test pattern to the read value in order to identify potential power integrity issues with the integrated circuit;

(j) until all of the N-bit test patterns have been transmitted to the N data pins, repeating steps (c-i).

In one embodiment, a computerized method for analyzing power integrity of an integrated circuit having a plurality of pins configured for coupling with an electronic device, wherein a first subset of the plurality of pins comprise power pins that are configured for coupling with a voltage source via the electronic device, a second subset of the plurality of pins comprise ground pins configured for coupling with a reference voltage via the electronic device, and a third subset of the plurality of the pins comprise address pins configured for coupling with one or more address buses that communicate address bits via the electronic device, comprises:

(a) identifying a set of N address pins that are each associated with N-bit address bus, wherein L of the N address pins are identified as being vulnerable to power integrity issues;

(b) determining a plurality M of N-bit first addresses and a corresponding plurality of N-bit test addresses;

(c) writing a first data value to each of a plurality of memory addresses that are addressable by the address bus;

(d) selecting one of the N-bit first addresses and a corresponding one of the N-bit test addresses;

(e) driving at least some of the N address pins according to the selected N-bit first address;

(f) driving at least some of the N address pins according to the selected N-bit test address;

(g) transmitting a second data value on a data bus associated with the address bus;

(h) reading data values from each of the plurality of memory addresses;

(i) based on the read data values and the selected N-bit test address, identifying potential power integrity issues;

(j) until all of the N-bit test addresses have been driven on the N address pins, repeating steps (c-i).

In one embodiment, a system for identifying possible power integrity problems associated with an integrated circuit comprises a test environment for housing an integrated circuit and a computing device in data communication with the integrated circuit, the computing device comprising a first software module configured to initiate sequential transmission of pairs of data signals to a predetermined memory address, wherein for a selected pair of data signals a first data signal of the selected pair is written to the predetermined memory address followed by writing of the second data signal of the selected pair to the same predetermined memory address, the first software module further configured to read a value of the predetermined memory address after each second data signal of respective pairs of data signals is written to the predetermined memory address and a power integrity module configured to identify possible power integrity problems based at least on comparison of read values and corresponding second data signal.

### BRIEF DESCRIPTION OF THE DRAWINGS

FIGS. 1A, 1B, and 1C are diagrams illustrating pin layouts for sample integrated circuits.

FIG. 2A is a diagram illustrating a PCB comprising of a plurality of chips in communication with a power integrity system.

FIG. 2B is a block diagram illustrating one embodiment of a sample power integrity system.

FIG. 3 is a flowchart illustrating one embodiment of a method of performing power integrity tests for each of a plurality of ambient profiles.

FIG. 4 is a flowchart illustrating one embodiment of a method of analyzing power integrity of pins associated with a data bus.

FIG. 5 is a flowchart illustrating one embodiment of a method of analyzing power integrity of pins associated with an address bus.

FIG. 6 is a flowchart illustrating one embodiment of a method of analyzing pins of an integrated circuit that are associated with two or more data and/or address buses that are driven by different bus clocks.

### DETAILED DESCRIPTION OF CERTAIN EMBODIMENTS

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

As used herein, the terms “trace,” “path,” “connection,” and “transmission line” each refer to electrical connections, such as connections between one or more components on a PCB. The junction of two or more electrical connections forms a “node.”

As used herein, the term “electrical signal” and “signal” refer to electrical signals, such as analog and/or digital data signals, that may be received by a PCB, transmitted on one or more traces on the PCB, and/or transmitted from the PCB to other devices.

As used herein, the terms “microchip,” “chip,” and “IC” refer to miniaturized electronic circuits constructed of individual semiconductor devices and/or passive components that are bonded to a substrate. A chip may comprise, for example, a processor, memory device, application specific integrated circuit (ASIC) and/or field programmable gate array (FPGA).

As used herein, the term “pin” refers generally to an electrical connection member of an integrated circuit, PCB, or other electric device. In one embodiment, pins comprise contact pads or leads of an integrated circuit or PCB.

As used herein, the term “power integrity” refers generally to a power distribution system's ability to provide sufficient power to its associated chips/components. Thus, power integrity of a chip or PCB depends on characteristics of driver(s), receiver(s), PCB traces to interconnect the chips, and any other characteristic that may affect power delivery. One power integrity problem may occur with reference to pins of an integrated circuit that are far from a power and/or ground pin of the integrated circuit or far from power and/or ground layers without proper decoupling capacitors of the PCB. Such power integrity problems may increase if the power and/or ground pins are demanded to change digital states (e.g., from “0” to “1” or vice versa) repeatedly in very high speeds. Another power integrity problem may arise for high speed signal pins that are crowded into a small area. The power integrity problem may arise when multiple groups of high frequency signal pins like address and/or data pins are concurrently active (e.g., receiving or transmitting address and/or data bits from a host device), reducing the power that is available to the groups of buses address and/or data pins. In either case, certain pins may not be properly powered (e.g., may not have enough power) to accurately toggle the groups of signals (e.g. data and/or address signals) that are transmitted to/from the pins, causing the data transmitted through the pins to be corrupted in some manner.

The description below provides several examples of test methods and systems, where the tests are performed with reference to pins of an integrated circuit. However, the pins described herein may include pins of a PCB or any other electric device having a connector that includes power connectors, ground connectors, and one or more of data and address connectors. Thus, any description of pins of an integrated circuit may be read to also describe any other pins of an electrical and/or communication device.

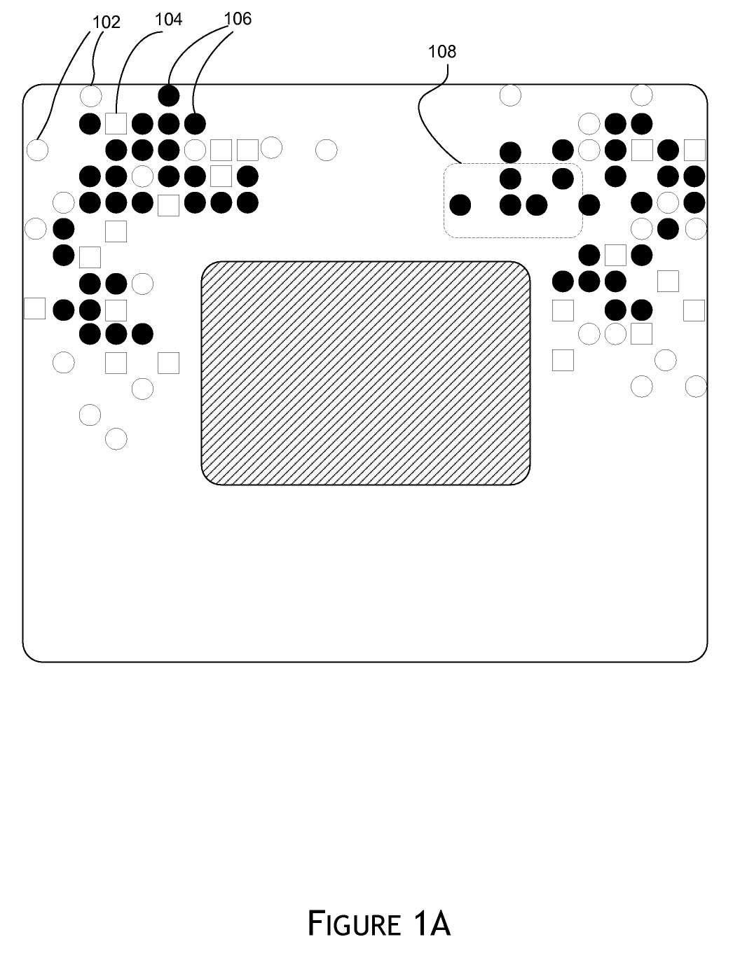

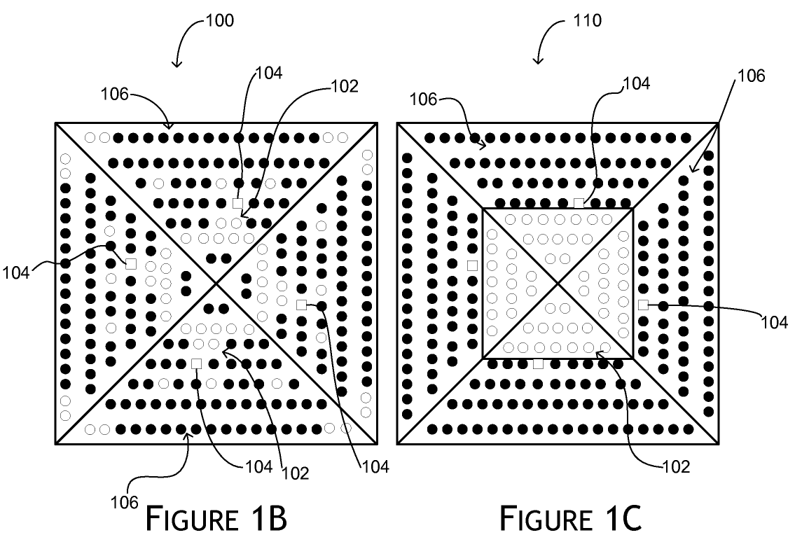

FIGS. 1A, 1B, and IC are diagrams illustrating pin layouts for three sample integrated circuits. In today's integrated chips, it is very typical to see multiple power rails and clocks in one chip. As the throughput requirement is increased, the width and the speed of address and data buses are getting wider and higher. FIG. 1A illustrates a partial chip pinout of a Motorola PowerPC MPC360 CPU. In the embodiments of FIGS. 1A, 1B, and 1C, the pin layouts include power pins 102 (illustrated as hollow circles), ground pins 104 (illustrated as hollow squares) and data/address pins 106 (illustrated as solid circles). In one embodiment, the data/address pins 106 are configured for coupling with a 64-bit wide data bus driven by 2.5V power supply delivered to the bus via one or more power pins 102 and ground pins 104. The data bus may comprise, for example, a primary DDR data bus running at minimum 266 MHz double rated clock that is updated with new data at both the rising and falling edges of the clock.

In the embodiment of FIG. 1A, only a subset of the pins of the chip are illustrated. In this embodiment, the power pins 102 and the ground pins 104 are scattered among the data pins 106. As those of skill in the art will recognize, for a double edge rated clock chip, the risk of power integrity issues increases in comparison to a single edge rated clock chip. The problem can be even worse if the PCB design is lacking of power distribution capability. In FIG. 1A, an example subset 108 of data pins 106 that might be more susceptible to power integrity issues are indicated. In certain embodiments, only those pins that are likely susceptible to power integrity issues, e.g., subset 108, are selected for power integrity testing using one or more of the systems and methods described herein.

As illustrated in FIG. 1B, power pins 102 (illustrated as hollow circles) and ground pins 104 (illustrated as hollow squares) are distributed throughout the entire chip 100, sometimes surrounding data/address pins 106 (illustrated as solid circles). In the embodiment of FIG. 1C, the power pins 102 are positioned around a central portion of the chip, with the ground pins 104 surrounding the power pins 102 and the data/address pins 106 on the periphery of the chip 110. Depending on the embodiment, the power and ground pins may be positioned in order to achieve the best power distribution (e.g., FIG. 1B) or to provide good power to the chip core and reduce noise (e.g., FIG. 1C). As those of skill in the art will recognize, the power, ground, data, and address pins of an integrated circuit may be distributed in any number of other manners. Given the variations in distribution of power and ground pins on an integrated circuit and/or PCB, the power integrity of each chip design may vary. In certain embodiments, those address and/or data pins that are furthest from the power and/or ground pins are most susceptible to power integrity issues. In one embodiment, only those address and/or ground pins that are most susceptible to power integrity issues are tested using the systems and methods described herein.

In one embodiment, after each group of pins associated with respective buses have been tested, a chip level test may be performed. For example, power integrity tests that monitor multiple buses driven by different clocks having simultaneously or near simultaneous transitions may be performed.

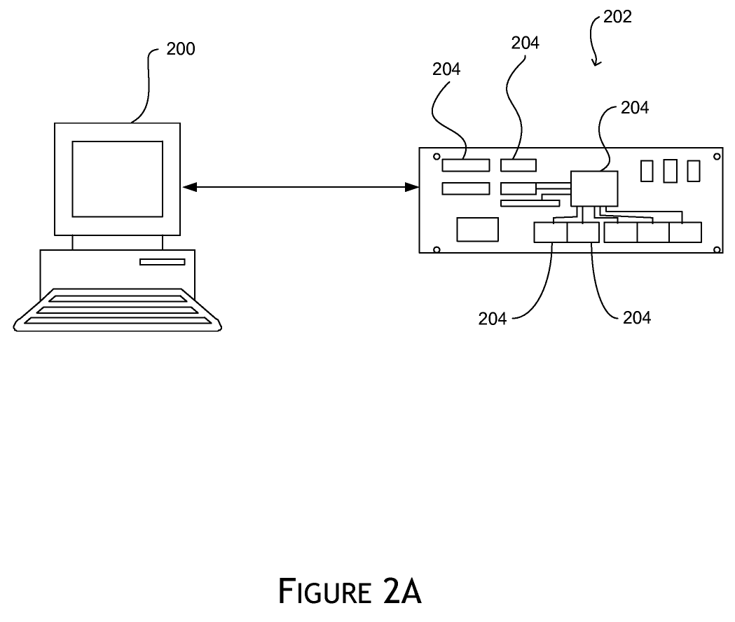

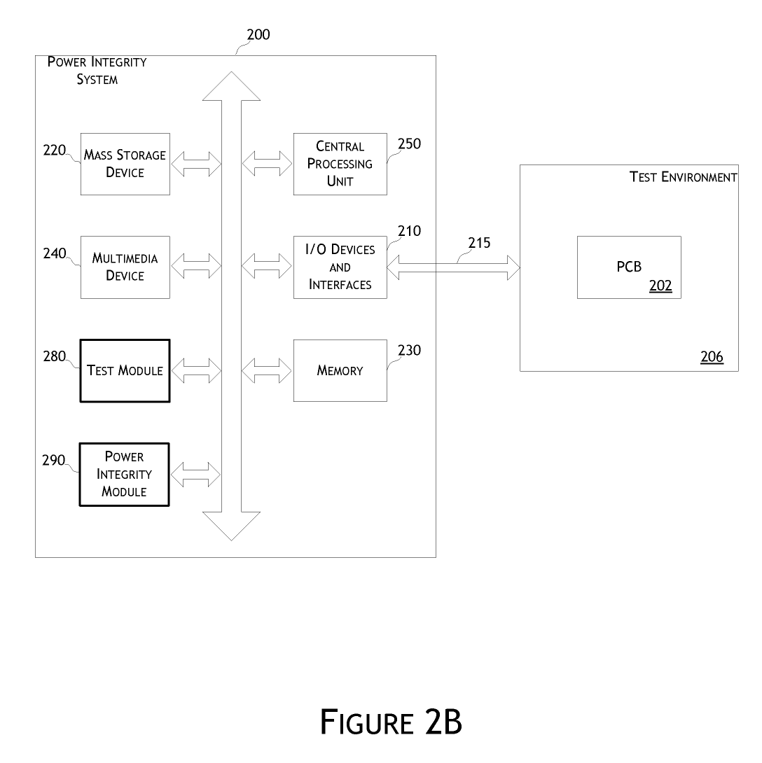

FIG. 2A is a diagram illustrating a PCB 202 having a plurality of chips 204 mounted thereon, wherein the PCB 202 is in communication with a power integrity system 200 (also referred to herein simply as the system 200). As described in further detail below, the power integrity system 200 may be configured to interact with one or more of the integrated circuits 204 and/or the PCB 202 in order to evaluate power integrity of the PCB 202 and/or chips 204.

FIG. 2B is a block diagram illustrating one embodiment of the sample power integrity system 200 in communication with the PCB 202 in a test environment 206. In one embodiment, the test environment 206 is configured to create one or more ambient profiles for testing of the PCB 202, where an ambient profile comprises one or more of a specific temperature, humidity, and/or other ambient characteristic. Thus, the test environment 206 allows for testing of the PCB 202 and any chips that are coupled to the PCB 202 at each of a number of ambient conditions. Depending on the embodiment, the functionality described below with reference to certain components and modules of the system 200 may be combined into fewer components and modules or further separated into additional components or modules.

The exemplary power integrity system 200 comprises one or more computing devices, such as a desktop, notebook, server, or handheld computer, for example. In the embodiment of FIG. 2B, the power integrity system 200 comprises a memory 230, such as random access memory (RAM) for temporary storage of information and a read only memory (ROM) for permanent storage of information, and a mass storage device 220, such as a hard drive, diskette, or optical media storage device. The mass storage device 220 may comprise one or more hard disk drive, optical drive, networked drive, or some combination of various digital storage systems. In one embodiment, the mass storage device 220 stores one or more logs indicating results of power integrity tests that are performed on a chip. The power integrity system 200 also comprises a central processing unit (CPU) 250 for computation. Typically, the modules of the power integrity system 200 are in data communication via one or more standards-based bus system. In different embodiments of the present invention, the standards based bus system could be Peripheral Component Interconnect (PCI), Microchannel, SCSI, Industrial Standard Architecture (ISA) and Extended ISA (EISA) architectures, for example.

The power integrity system 200 is generally controlled and coordinated by operating system software, such as the UNIX, Linux, Ubuntu, Windows 95, 98, NT, 2000, XP, Vista, or other compatible operating systems. In Macintosh systems, the operating system may be any available operating system, such as Mac OS X. In other embodiments, the power integrity system 200 may be controlled by a proprietary operating system. Conventional operating systems control and schedule computer processes for execution, perform memory management, provide file system, networking, and I/O services, and provide a user interface, such as a graphical user interface (GUI), among other things.

The exemplary power integrity system 200 includes one or more of commonly available input/output (I/O) devices and interfaces 210, such as a keyboard, mouse, touchpad, and printer. In one embodiment, the I/O devices and interfaces 210 include one or more display devices, such as a monitor, that allow the visual presentation of data to a user. More particularly, display devices provide for the presentation of GUIs, application software data, and multimedia presentations, for example. In one embodiment, a GUI includes one or more display panes in which the power integrity results associated with the PCB 202 may be displayed. The power integrity system 200 may also include one or more multimedia devices 240, such as speakers, video cards, graphics accelerators, and microphones, for example.

In the embodiment of FIG. 2B, the I/O devices and interfaces 210 provide a communication interface to various external devices. For example, the power integrity system 200 is in data communication with the test environment 206 that houses one or more PCBs. In the embodiment of FIG. 2B, a communication link 215 carries communication signals between the power integrity system 200 and the test environment 206. In one embodiment, the communication link 215 comprises one or more connection interfaces, such as JTAG or BDM connection interfaces, for example, configured to communicate data signals between the power integrity system 200 and the PCB 202 housed in the test environment 206. In one embodiment, the communication link 215 comprises one or more memory bus and/or data bus that carry memory address and/or data, respectively, to the PCB 202. Depending on the embodiment, the power integrity system 200 may communicate with a plurality of PCBs via the I/O devices and interfaces 210, such as via a plurality of JTAG and/or BDM connection interface.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein may be implemented as either software or hardware modules. Generally, the modules described herein refer to logical modules that may be combined with other modules or divided into sub-modules despite their physical organization or storage.

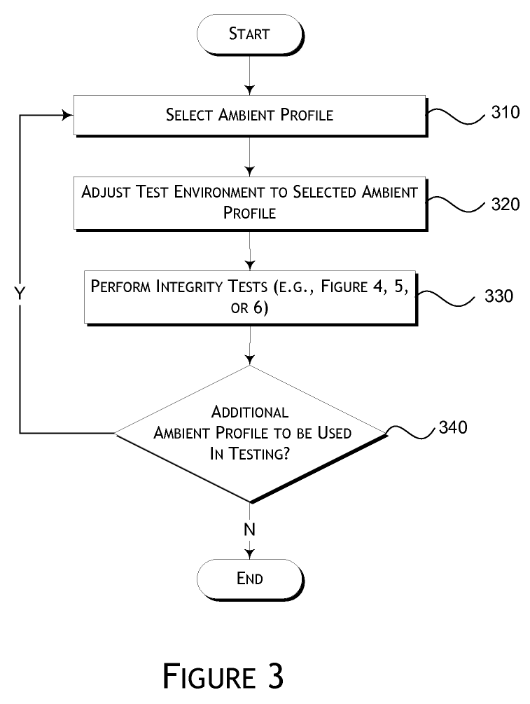

The exemplary signal integrity system comprises a test module 280 that is configured to transmit signals to the PCB 202, where the signals are selected for testing of power integrity of the PCB 202 and/or one or more chips associated with the PCB 202. For example, the signals that are transmitted to the PCB 202 may include memory addresses and data values to be stored in specific memory addresses that addressable by the connection interface 215. FIGS. 3-7, for example, describe exemplary methods of transmitting signals to a chip in order to test power integrity of selected (or all) pins of the chip.

In one embodiment, the test module 280 comprises one or more test algorithms, such as a suite of test software that may be written in low level language that is coupled with hardware seamlessly. In one embodiment, the power integrity tests are sensitive to groups of signals being toggled/switched simultaneously or nearly simultaneously as the result of synchronizing with the reference clock. If the test module 280 introduces delays to drive the actual groups of signals of the chips and PCBs, the effectiveness of the tests may be discounted or may be null even through the right test algorithm(s) is deployed, especially implemented by some high level application languages.

The exemplary power integrity system 200 also comprises a power integrity module 290 that is configured to analyze the results of the testing performed by the test module 280 and output data indicative of potential power integrity problems with the PCB 202 and/or its associated chips. In one embodiment, for example, the power integrity module analyzes a log file generated by the test module 280 and determines pins of the chips that potentially have power integrity problems.

### Sample Test Environment

FIG. 3 is a flowchart illustrating one embodiment of a method of performing a power integrity test for each of a plurality of ambient profiles. As noted above, an ambient profile includes information regarding one or more desired ambient characteristics for testing a product, including, for example, one or more of a temperature and a humidity. The methodology of FIG. 3 advantageously allows testing of a product's power integrity at each of a plurality of ambient conditions, such as by adjusting the ambient characteristics of a test environment in between performing a series of power integrity tests. Depending on the embodiment, the method of FIG. 3 may include additional or fewer blocks and the blocks may be performed in a different order than is illustrated. The method of FIG. 3 may be performed by a computing system, such as the power integrity system 200, or any other suitable computing system.

Beginning in block 310, an ambient profile for testing the power integrity of a chip is selected. In one embodiment, a series of ambient profiles are determined prior to testing of the chip in the test environment 206 (e.g., FIG. 2B). In one embodiment, the ambient profile may be determined based on the product environmental specification. In that embodiment, one of the ambient profiles is selected in block 310 for use in testing the power integrity of the chip. In other embodiments, ambient profiles may be determined on the fly, either automatically by the power integrity system 200 or manually by an operator of the system 200, in order to allow customization of the ambient profiles for use in testing the chip. As used herein, the term “ambient profile,” refers to one or more ambient characteristics, including, for example, one or more of temperature and humidity.

Moving to block 320, the ambient characteristics of the test environment are adjusted according to the ambient profile selected in block 310. In one embodiment, the test environment 206 (e.g., FIG. 2B) comprises an enclosed rectangular structure that may continually adjust the ambient characteristics inside the chamber, such as in response to commands received from the test module 280 of the power integrity system 200. Use of the test environment 206 may allow testing of the PCB 202 under a varying array of possible temperature and/or humidity conditions that the PCB 202 would face in a real world environment. The test environment 206 may accelerate real world ambient environments such that an expected ten year lifespan of the PCB 202, or other multi-year lifespan, can be simulated in a few hours or less using the test environment 206 and the power integrity system 200. In one embodiment, the PCB 202 may be tested by the signal integrity system 200 without the test environment 206, such as by placing the PCB 202 on a static-free tabletop surface.

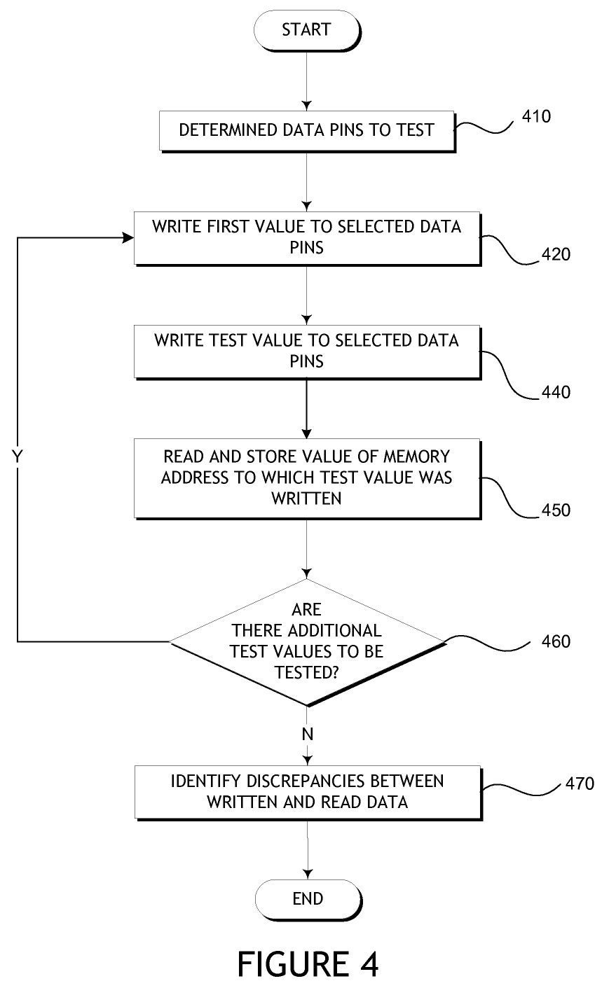

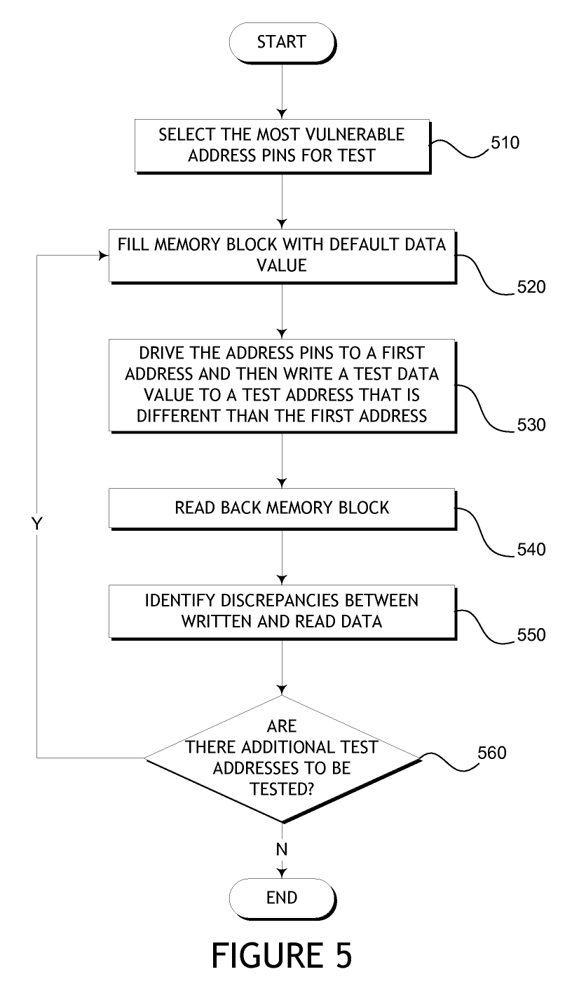

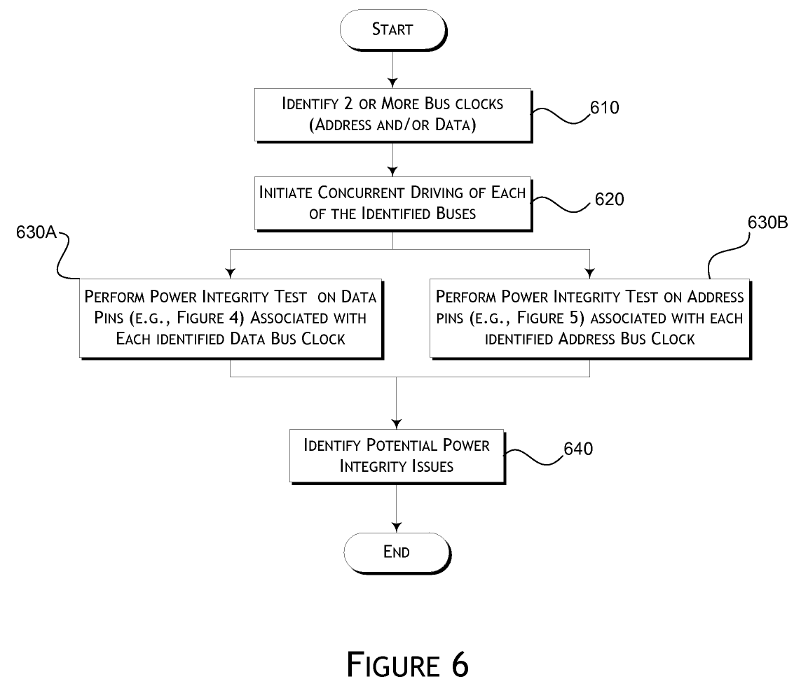

Next, in block 330, one or more power integrity tests are performed on the chip in the test environment 206. As described in further detail below with reference to FIGS. 4-7, for example, various combinations of data may be written to and read from selected addresses of the chip under test in order to identify potential power integrity problems with the chip and the PCB.

In block 340, the test module 280, for example, determines if the current chip under test is to be tested using one or more additional ambient settings. If additional ambient profiles remain, the method returns to block 310 where one of the remaining ambient profiles is selected and the chip is again tested under the environmental conditions indicated in the newly selected ambient profile. If no additional ambient profiles are located, the method is complete. In one embodiment, data regarding the potential power integrity issues with the chip under test are provided to a user of the system 200 and one or more user interfaces and/or printed documents. In one embodiment, the potential power integrity issues are transmitted to a chip design module, such as software that aids in configuration of pins on an integrated circuit, so that the chip design module may reconfigure layout of the pins of the integrated circuit in order to reduce the potential power integrity issues.

### Sample Data Pin Power Integrity Test

FIG. 4 is a flowchart illustrating one embodiment of a method of analyzing power integrity of pins associated with a data bus. As those of skill in the art will recognize, certain pins of an integrated circuit, such as those illustrated in exemplary FIGS. 1A, 1B, and IC may be configured for coupling to one or more address and data buses of a host microprocessor, such as a microprocessor on a PCB. For example, a chip may include 32 (or any other quantity) pins that are configured for coupling to a 32 bit data bus of a microprocessor or host system. The method of FIG. 4 illustrates one embodiment of a method of testing the power integrity of data pins of an integrated circuit. Depending on the embodiment, the method of FIG. 4 may include additional or fewer blocks and the blocks may be performed in a different order than is illustrated. The method of FIG. 4 may be performed by a computing system, such as the power integrity system 200, or any other suitable computing system.

Beginning in block 410, one or more data pins to be tested on the chip in the test environment (if used) are selected. As noted with reference to FIG. 1A, for example, only certain data pins of a chip may be selected for power integrity analysis. For example, in one embodiment those data pins that are positioned far away from power and/or ground pins may also be selected for power integrity testing. In other embodiments, all of the data pins are selected for power integrity testing. In one embodiment, a series of data pins that are associated with a particular data bus are selected in block 410. For example, four data pins that are associated with a four bit data bus may be selected in block 410. A four bit data bus may carry 24 possible combinations of data values.

Moving to block 420, a first known value is written to the selected data pins. For example, a value of zero may be written to each of the selected data pins. In other embodiments, the first known value may be any other value, such as all “1”s or a combination of “0”s and “1”s, such as “0101” or “1010” for a four bit data bus. In one embodiment, a single memory address may be used for the writing/reading of data bits transmitted via the selected data pins. For example, a single memory address may be written with the first know value, which is transmitted to the memory via the selected data pins. In one embodiment, the first value changes as iterations of a test procedure are performed. For example, the first value may be selected from one of the values in the “First Value Set” column of Table 1, below, according to an iteration of the test method.

Next, in block 440, a test value is written to the selected data pins. As will be described below, the value of the data pins will be read (block 450) and then the method will repeat with additional test values (blocks 460, 470). Thus, the method of FIG. 4 performs a repeated change from a first value to respective test values in order to detect power integrity issues of the selected data pins. Table 1, below illustrates a series of example test values that may be written to an exemplary four data pins (e.g. associated with a four bit data bus) at sequential iterations of the method blocks 420-470. These values are provided for purpose of illustrate and do not limit the scope of values that may be used in other data pin power integrity tests. In certain embodiments, the first value comprises any possible bit combination and the second value comprises the complement of the first value, wherein bit combinations may be selected in sequential order (e.g., Table 1), or in any other order.

The test values of the “Test Value Set” in Table 1 may be written to an exemplary 4 data pins (e.g., transmitted to the chip via the selected 4 pins and stored in a memory of the chip) of a chip under test in sequential iterations of the method 420-470. In one embodiment, each of the test value sets 1-4 may be used in writing to a selected 4 data pins, such as by using the test values of Set 1, then Set 2, and so on. In embodiments where other quantities of pins are selected for testing (e.g., in block 410 of FIG. 4), such as 8, 16, 32, 64, or 128, for example, the first and test values may include respectively higher numbers of values. For example, for 16 data pins associated with a 16 bit data bus, the test values may begin with “0000000000000000”, “00000000000000100”, “0000000000000100”, “0000000000001000”, “0000000000010000”, “00000000000100000”, “0000000001000000”, “0000000010000000”, “0000000100000000”, and so on, with the first values being the complement of the respective test values.

| | First Value | Test Value | |
|---|---|---|---|
| Iteration | Set | Set | |
| 1 | 0000 | 1111 | Read back |
| 2 | 0001 | 1110 | Read back |
| 3 | 0010 | 1101 | Read back |
| 4 | 0100 | 1011 | Read back |
| 5 | 1000 | 0111 | Read back |
| 6 | 0011 | 1100 | Read back |
| 7 | 0101 | 1010 | Read back |
| 8 | 1001 | 0110 | Read back |
| 9 | 0110 | 1001 | Read back |
| 10 | 1010 | 0101 | Read back |
| 11 | 1100 | 0011 | Read back |
| 12 | 0111 | 1000 | Read back |
| 13 | 1011 | 0100 | Read back |
| 14 | 1101 | 0010 | Read back |
| 15 | 1110 | 0001 | Read back |
| 16 | 1111 | 0000 | Read back |

In other embodiments, the test values may include any other series of values that are predetermined prior to beginning testing and/or that are dynamically determined as testing of the data pins is performed.

Next, in block 450, values are read from the memory location where the test values were written. These read values may be compared to the values that were written to the memory location (or attempted to be written to the memory location) in order to determine if the data was transmitted appropriately to and/or from the data pins or, conversely, if power integrity issues corrupted the data that was intended for transmission by the data pins.

Moving to block 460, the system 200 determines if there are additional test values to be transmitted via the selected data pins. As noted above, in one embodiment combinations of test values, such as the test value sets illustrated in Table 1, may be sequentially selected as test values for writing to the selected data pins. Thus, if the system 200 determines that there are additional test values to be written to the selected data pins, the method moves to block 420 where the first value is set to the next first value (e.g., the next value in the “First Value Set” column of Table 1) and the test value is set to a next test value (e.g., the next value in the “Test Value Set” column of Table 1) to be written to the selected data pins. For example, if the test value of iteration one of test value data set one (e.g., “0000”) was just written to the selected data pins, the test values selected in the next block 420 may be the test value in iteration two of the test value data set one (e.g., “0001”). After setting a new first value and/or test value, the method continues to blocks 420-460 where the selected data pins are set to the first value (block 420), the new test value is written to the selected data pins (block 440), and the value of the memory address to which the test value was written is read (block 450).

If there are no additional test values to be tested for the selected data pins, the method continues to block 470 where discrepancies between written and read data for the selected data pins are identified. In one embodiment, the power integrity module 290 (FIG. 2B) executes one or more algorithms to compare the written and read data in order to identify potential power integrity problems with the selected data pins. For example, if a data value “00001111” is written to memory associated with eight selected data pins (e.g., block 410), but the data value “00011111” is read from the memory associated with the eight selected data pins (e.g., block 450), the power integrity module 290 may indicate a potential power integrity problem with the fifth pin from the least significant pin of the selected data pins.

The sample method of FIG. 4 includes writing of first values that are compliments of subsequently written test value. In other embodiments, the first value may be a static value, such as all “0”s or all “1”s, for example, while the test values change for each iteration of testing. In other embodiments, the test values may be a static value, such as all “0”s or all “1”s, for example, while the first values change for each iteration of testing. The first and test values in Table 1 are provided for purposes of illustrating the method of FIG. 4 and do not limit the bit patterns that may be used in testing data pins.

### Sample Address Pin Power Integrity Test

FIG. 5 is a flowchart illustrating one embodiment of a method of analyzing power integrity of pins associated with an address bus. As those of skill in the art will recognize, certain pins of an integrated circuit, such as those illustrated in exemplary FIGS. 1A, 1B and 1C, are configured for coupling to one or more address buses of a host microprocessor, such as a microprocessor on a PCB. For example, a chip may include 32 pins that are configured for coupling with a 32 bit address bus. Of course, any other size address bus may also be configured for coupling to a corresponding quantity of pins of an integrated circuit. The method of FIG. 5 illustrates one embodiment of a method of testing the power integrity of address pins of an integrated circuit. Depending on the embodiment, the method of FIG. 5 may include additional or fewer blocks and the blocks may be performed in a different order than is illustrated. The method of FIG. 5 may be performed by a computing system, such as the power integrity system 200, or any other suitable computing system.

Beginning in block 510, one or more address pins are selected for power integrity testing. For example, three address pins Addr 6, 2 and 0 that are associated with an eight bit address bus Addr [7:0] may be selected in block 510 (e.g., three of the vulnerable pins in subset 108 of FIG. 1A). Similarly, up to N address pins that are associated with an N-bit address bus may be selected for power integrity testing in block 510. As noted above with reference to FIG. 1A, for example, in one embodiment only certain address pins are selected for power integrity testing, such as those address pins that are located far from power/ground pins of the chip and or those pins located in a very dense area.

Moving to block 520, a first data value (e.g. for eight-bit memory words that are addressable by three-bit addresses, the hexadecimal value 5A (binary “10100101”) may be the default data value) is written to each memory address of a memory block associated with the selected address pins. In one embodiment, the range of the memory block is determined by the highest vulnerable pin. For example, if pin 7 (e.g., Addr 6) is the highest pin selected as vulnerable, only address lines Addr [7:0] are selected in block 510 (rather than all 256 addresses that are addressable by the eight-bit bus), the memory block that is filled with the first data value comprises 27 addresses (e.g., address 0-address 128).

Moving to block 530, an address of the memory block is selected for power integrity testing. In one embodiment, each of the memory addresses associated with the address pins may be sequentially tested via repetition of blocks 520-570. Using the above 8 bit wide address bus Addr [7:0] as an example, where address pins associated with address bits 6, 2 and 0 have been identified as vulnerable pins, the test strategy illustrated in Table 2 is to toggle only those address bits that have been identified as vulnerable in one clock cycle. In contrast to the data bit test, the address bit test is not a direct test since address bits are not bi-directional—they cannot be read back as data bits. Accordingly, in one embodiment the power integrity of address pins are tested by writing a known value to a single memory address and then reading back the content of the entire (or a substantial portion) of the block of memory.

TABLE 2

| | First Address Set | Test Address Set |
|---|---|---|
| Iteration | Addr[7654 3210] | Addr[7654 3210] |
| 1 | 0000 0000 | 0100 0101 |
| 2 | 0000 0001 | 0100 0100 |
| 3 | 0000 0100 | 0100 0001 |
| 4 | 0100 0000 | 0000 0101 |
| 5 | 0000 0101 | 0100 0000 |
| 6 | 0100 0001 | 0000 0100 |
| 7 | 0100 0100 | 0000 0001 |
| 8 | 0100 0101 | 0000 0000 |

In block 530, a first address (e.g., selected from the first address set of Table 2) drives the selected address pins, followed by a test address (e.g., selected from the test address set of Table 2 and corresponding to the selected first address) driving the selected address pins. In one embodiment, only the values of the selected address pins, which may be less than all of the address pins associated with a data bus, are changed in iterations of the address pin testing. Thus, in the example where address bits 6, 2, 0 of an eight-bit address bus are identified as vulnerable pins, the unselected address pins Addr 7, 5, 4, 3 and 1 may all be set as either “1” or “0”. In the example of Table 2, the unselected address bits are set to “0” throughout multiple iterations of the address pin testing. In the embodiment of Table 2, the test addresses are the complements of respective first addresses. With the address pins driven with a test address, a second data value, such as hexadecimal “5A” for an eight-bit memory word, is written. In one embodiment, power integrity problems with the selected pins may be encountered due to the flipping of the vulnerable pins to the first address and then immediately to the test address (sometimes in the same clock cycle, such as in DDR memory) before writing the second data value.

Next, in block 540, the data stored in each memory address of the memory block is read. Continuing the example above, even though pins associated with only three bits of an eight-bit bus are identified as vulnerable, all 128 addresses of a memory that is addressed by the bus are read. Thus, the method of FIG. 5 writes the second data value to only a selected memory address, but reads the data values from each memory address of the memory block in order to detect any corruption associated with the memory pins. For example, if the selected memory address is corrupted on the address pins, the second data value may be written to an unknown address of the memory block (e.g., block 540). Thus, each of the memory addresses of the memory block may be read at block 550 in order to determine where the second data value has been stored, if at all. Additionally, if a particular memory address is corrupted when writing data to the address, the memory address may be similarly corrupted when reading from that address. Thus, writing and reading from only the same memory address would not detect all corruptions (e.g. the same wrong address that the second data value was written to may be read in block 540 giving the impression that the data was appropriately written to the selected memory address). However, when power integrity corruption occurs on the address pins, the second value may be written to multiple memory addresses, such as addresses having only one bit different. By reading each of the addresses of the memory block, writing of the second data value in multiple addresses may more easily be detected. Another address corruption symptom is that READ and WRITE transactions cannot be fulfilled. Error messages like “out of memory range” or “illegal instruction” may be received.

In block 560, the test module 280 (e.g., FIG. 2) determines if there are additional addresses of the memory block to be tested, such as another iteration of first and test addresses, e.g., Table 2. In other embodiments, only certain combinations of memory addresses are selected for the power integrity test of FIG. 5.

FIG. 6 is a flowchart illustrating one embodiment of a method of analyzing pins of an integrated circuit that are associated with two or more data and/or address buses that are driven by different bus clocks. As those of skill in the art will recognize, the use of multiple bus clocks that drive data/address bit transitions at substantially the same time (e.g., nanoseconds to microseconds apart) increases a likelihood of power integrity problems with the chip. The method of FIG. 6 is one sample method of stressing the power capabilities of a chip by driving multiple buses concurrently and testing whether data and address pins are victims of power integrity corruption. Depending on the embodiment, the method of FIG. 6 may include additional or fewer blocks and the blocks may be performed in a different order than is illustrated. The method of FIG. 6 may be performed by a computing system, such as the power integrity system 200, or any other suitable computing system.

Beginning in block 610, the system 200, for example, identifies two or more bus clocks that drive data and/or address buses on an integrated circuit (or PCB). In one embodiment, the identified bus clocks each drive data buses. In another embodiment, the identified bus clocks each drive address buses. In another embodiment, at least one bus clock drives a data bus and at least one bus clock drives an address bus.

Moving to block 620, each of the identified bus clocks are enabled to drive their respective buses. With each of the bus clocks driving their buses, the method continues to blocks 630A and 630B, which advantageously are performed at least partially concurrently. In block 630A, one or more power integrity tests are performed on data pins associated with each of the identified data bus clocks that drive data buses. For example, the test module 280 and/or power integrity module 290 (FIG. 2B) may perform the method of FIG. 4 for multiple groups of data pins that are associated with different data buses and bus clocks. Because the bus clocks do not necessarily operate at the same frequency, multiple separate data pin analysis methods (e.g., FIG. 4) may be performed concurrently. In block 630B, one or more power integrity tests are performed on address pins associated with each of the identified address bus clocks that drive address buses. For example, the test module 280 and/or power integrity module 290 (FIG. 2B) may perform the method of FIG. 5 for multiple groups of address pins that are associated with different data buses and bus clocks. Because the bus clocks do not necessarily operate at the same frequency, multiple separate address pin analysis methods (e.g., FIG. 5) may be performed concurrently. Similarly, one or more data pin analysis method (e.g., FIG. 4) and one or more address pin analysis method (e.g., FIG. 5) may be performed concurrently.

In block 640, the power integrity system 200 (e.g., the power integrity module 290) identifies any potential power integrity issues located by the concurrent data and/or address pin analysis methods.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A computerized method for analyzing power integrity of an integrated circuit having a plurality of pins configured for coupling with an electronic device, wherein a first subset of the plurality of pins comprise power pins that are configured for coupling with a voltage source via the electronic device, a second subset of the plurality of pins comprise ground pins configured for coupling with a reference voltage via the electronic device, and a third subset of the plurality of the pins comprise data pins configured for coupling with one or more data buses that communicate data bits via the electronic device, the method comprising:
(a) identifying a set of N data pins that are each associated with one of the data buses;
(b) determining a plurality M of N-bit reset patterns and a corresponding plurality of N-bit test patterns;
(c) selecting a first memory address of the integrated circuited for storage of data bits received by the N data pins;
(d) selecting one of the N-bit reset patterns;
(e) transmitting the selected N-bit reset pattern to the N data pins;
(f) selecting one of the plurality of N-bit test patterns that correspond to the selected N-bit reset pattern;
(g) transmitting the selected N-bit test pattern to the N data pins;
(h) reading a value of the first memory address;
(i) comparing the selected N-bit test pattern to the read value in order to identify potential power integrity issues with the integrated circuit;
(j) until all of the N-bit test patterns have been transmitted to the N data pins, repeating steps (c-i).

2. The method of claim 1, wherein N is 4, 8, 16, 32, 64, 128, or 256.

3. The method of claim 1, wherein the N-bit reset patterns are complements of their respective N-bit test patterns.

4. The method of claim 1, wherein M is equal to N raised to the second power.

5. The method of claim 1, further comprising outputting an indication of a possible power integrity issue in response to the comparing indicating a difference in the read value and the selected N-bit test pattern.

6. The method of claim 1, further comprising outputting one or more suggested changes to a pin layout of the integrated circuit in response to the comparing.

7. A computerized method for analyzing power integrity of an integrated circuit having a plurality of pins configured for coupling with an electronic device, wherein a first subset of the plurality of pins comprise power pins that are configured for coupling with a voltage source via the electronic device, a second subset of the plurality of pins comprise ground pins configured for coupling with a reference voltage via the electronic device, and a third subset of the plurality of the pins comprise address pins configured for coupling with one or more address buses that communicate address bits via the electronic device, the method comprising:
(a) identifying a set of N address pins that are each associated with N-bit address bus, wherein L of the N address pins are identified as being vulnerable to power integrity issues;
(b) determining a plurality M of N-bit first addresses and a corresponding plurality of N-bit test addresses;
(c) writing a first data value to each of a plurality of memory addresses that are addressable by the address bus;
(d) selecting one of the N-bit first addresses and a corresponding one of the N-bit test addresses;
(e) driving at least some of the N address pins according to the selected N-bit first address
(f) driving at least some of the N address pins according to the selected N-bit test address
(g) transmitting a second data value on a data bus associated with the address bus;
(h) reading data values from each of the plurality of memory addresses;
(i) based on the read data values and the selected N-bit test address, identifying potential power integrity issues;
(j) until all of the N-bit test addresses have been driven on the N address pins, repeating steps (c-i).

8. The computerized method of claim 7, wherein the driving at least some of the N address pins according to the selected N-bit first address is performed on a first edge of a clock signal and the driving at least some of the N address pins according to the selected N-bit test address is performed on a second edge of the same clock signal.

9. The computerized method of claim 7, wherein L is less than N.

10. The computerized method of claim 7, wherein L equals N

11. The computerized method of claim 7, wherein the at least some of the N address pins comprise only the L address pins such that the remaining address pins remain at a default value.

12. The computerized method of claim 11, wherein the default value is zero or one.

13. The computerized method of claim 7, wherein L bits of the N-bit first address that correspond to the L address pins are the inverse of the L bits of the N-bit test address that correspond to the L address pins.

14. The computerized method of claim 7, wherein the first data value and the second data value each comprises substantially alternating binary digits.

15. The computerized method of claim 7, wherein the plurality of addresses are selected based on one of the L address pins that is associated with a highest bit of the address bus.

16. The computerized method of claim 15, wherein the highest bit is less than a width of the address bus.

17. A computerized system for identifying possible power integrity problems associated with an integrated circuit, the system comprising:
a test environment for housing an integrated circuit;
a computing device in data communication with the integrated circuit and comprising:
a first software module configured to initiate sequential transmission of pairs of data signals to a predetermined memory address, wherein for a selected pair of data signals a first data signal of the selected pair is written to the predetermined memory address followed by writing of the second data signal of the selected pair to the same predetermined memory address, the first software module further configured to read a value of the predetermined memory address after each second data signal of respective pairs of data signals is written to the predetermined memory address; and
a power integrity module configured to identify possible power integrity problems based at least on comparison of read values and corresponding second data signal.

18. The computerized system of claim 17, wherein for at least some of the pairs of data signals, the first data signal is the complement of the second data signal.

19. The computerized system of claim 17, wherein the computing device further comprises:
a second software module configured to, for each of a plurality of sets of first addresses and corresponding second addresses,
initiate writing of a first data signal to each of a plurality of memory addresses, drive an address bus coupled to the integrated circuit with a selected first address, drive the address bus with a corresponding second address, and transmit a second data signal to a data bus associated with the address bus, the second software module further configured to read data values stored in each of the plurality of memory addresses after each second data signal is transmitted; and
the power integrity module is further configured to identify possible power integrity problems based at least on comparison of the read data values and the second address.

20. The computerized system of claim 19, wherein for at least some of the pairs of first and second addresses, the first address is the complement of the second address.

21. The computerized system of claim 17, wherein the test environment comprises a substantially hermetic chamber configured to adjust at least one of a temperature and humidity in response to signals from the computing device.
